(19) United States
(12) Patent Application Publication
(10) Pub. No.: US 2009/0132262 A1
(43) Pub. Date: May 21, 2009

(54) Proactively determining evidence issues on legal matters involving employee status changes

(75) Inventor: Deidre Paknad, Palo Alto, CA (US)

Correspondence Address: CARR & FERRELL LLP, 2200 GENG ROAD, PALO ALTO, CA, 94303, US

(73) Assignee: PSS Systems

(21) Appl. No.: 11/901,020

(22) Filed: Sep. 14, 2007

(51) Int. Cl. G06Q 10/00; G06F 17/30; G06F 17/40

(52) U.S. Cl. 705/1

(57) ABSTRACT

Exemplary systems and methods for determining potential evidence issues for employees having changing status. In exemplary embodiments, employee status information is accessed. Employee status information may comprise employee status change information or current employee status information. Information associated with one or more legal matters is also accessed. A status check is then performed to determine if there are status change employees. A status change employee comprises an employee having changing status or potential changing status that is associated with the one or more legal matters.

### CROSS REFERENCE TO RELATED APPLICATION

The present application is related to U.S. patent application Ser. No. 11/505,665, filed Aug. 16, 2006 and entitled “Systems and Methods for Utilizing Organization-Specific Classification Codes;” U.S. patent application Ser. No. 11/505,537, filed Aug. 16, 2006 and entitled “Systems and Methods for Utilizing an Enterprise Map to Determine Affected Entities;” U.S. patent application Ser. No. 11/512,880, filed Aug. 29, 2006 and entitled “Systems and Methods for Providing a Map of an Enterprise System,” which are all herein incorporated by reference.

### BACKGROUND OF THE INVENTION

1. Field of the Invention

Embodiments of the present invention relate generally to data management and more particularly to determining evidence issues involving employee status changes.

2. Description of Related Art

Conventionally, information retrieval is accomplished by searches using keywords, people, and dates. If a specific set of information is sought, very specific parameters may need to be input into a system that maintains the information in order to locate the set of information.

For litigation, tax, or regulation purposes, data and evidence within a company is required to be preserved in anticipation of, or during, the legal matter. Traditionally, the company will identify affected employees and systems likely to be associated with the legal matter related data and evidence. In large companies, however, the identification of affected employees and systems is often complex. The complexity may be exacerbated by hundreds or thousands of business systems, drives, and cabinets that house the data. Furthermore, a large company may have any number (e.g., hundreds or thousands) of active legal matters at any one time. Additionally, employee turnover and reassignment may be frequent, making it difficult to determine who is involved in any particular legal matter. Oftentimes, an employee or system may be involved in more than one legal matter which will require the employee or system to preserve data such as documents. Sometimes, the preserved data may transcend more than one legal matter.

In a large company with numerous employees, a significant number of employees may be departing or transferring between departments at any given time period. This status change is often unknown to legal staff associated with the company. This may create legal risks since the legal staff may need to take action to ensure preservation of information, knowledge, or potential evident from the employee prior to their change in status. Furthermore, exit procedures such as computer recycling and data destruction may occur without legal approval or involvement. As such, there is a need for a system and method that proactively determines evidence issues on legal matters involving employee status changes.

### SUMMARY OF THE INVENTION

Embodiments of the present invention provide systems and methods for determining evidence issues on legal matters involving employee status changes. According to one embodiment, employee status information is accessed. Employee status information may comprise employee status change information or current employee status information. In various embodiments, the employee status information may be accessed from a human resources system, a payroll system, or any other list or system associated with a company that maintains employee status or status change information.

Information associated with one or more legal matters is also accessed. The legal matter information may be stored in a legal matter repository. The legal matter information comprises legal matters, affected people and systems, associated contact information, legal holds, and requests.

A status check is then performed to determine if there are any status change employees. A status change employee comprises an employee having changing status or potential changing status that is associated with the one or more legal matters. In exemplary embodiments, the status check is performed by a status check module.

Based on the results of the status check, various workflow and notifications may be generated. For example, legal staff associated with a legal matter having a status change employee may be notified of the status change employee and given a workflow to expedite evidence collection from the status change employee.

### BRIEF DESCRIPTION OF THE DRAWINGS

FIG. 1 is a diagram of an exemplary environment in which embodiments of the present invention may be practiced.

FIG. 2 is a block diagram of an exemplary legal matter management system.

FIG. 3 is a block diagram of an exemplary legal communication and collection engine.

FIG. 4 is a flowchart of an exemplary method for determining evidence issues involving employee status changes.

FIG. 5 is a screenshot of a user interface providing top level information for a matter.

FIG. 6 is a screenshot of a user interface providing a list of affected people.

FIG. 7 is a screenshot of a user interface providing a master list for a matter.

### DETAILED DESCRIPTION OF EXEMPLARY EMBODIMENTS

Embodiments of the present invention provide an exemplary system and method for utilizing an enterprise map, database of legal matters, and knowledge of employee statuses including potential status changes in order to determine evidence issues of legal matters involving employee status change. The enterprise map comprises relationships between various objects that represent the data, custodians, and custodial systems comprising the enterprise. Based on these relationships in the enterprise map, affected people and systems (e.g., entities under an obligation of a legal hold) may be determined. Affected people may comprise individual employees, record coordinators and administrators responsible for a class of information or associated with an information repository, and system administrators and IT staff responsible for the information repositories along with names, contact information, e-mail addresses, organizations, and location of the employees. Affected systems may comprise the repositories storing data of interest (e.g., data under a legal hold). In some embodiments, the affected people may have physical possession of the data of interest.

By cross-checking a list of one or more employees having status changes, including pending and potential status changes, with legal matters having legal holds or requests, data and evidence integrity may be insured for current or potential departing or transferring employees, employees planning or on sabbatical or maternity leave, or employees on reduction in force (RIF) lists (i.e., “status change employee”), for example. Legal holds comprise instructions to affected people (e.g., custodians) or stewards of an affected system (e.g., custodial system) to retain data or evidence that may be of interest in a legal matter. Requests represent workflow associated with the legal matter (e.g., production of evidence, interviews, etc.). In exemplary embodiments, the employees are referred to as “custodians” because they have custody of the evidence (e.g., documents, e-mails, files, etc.).

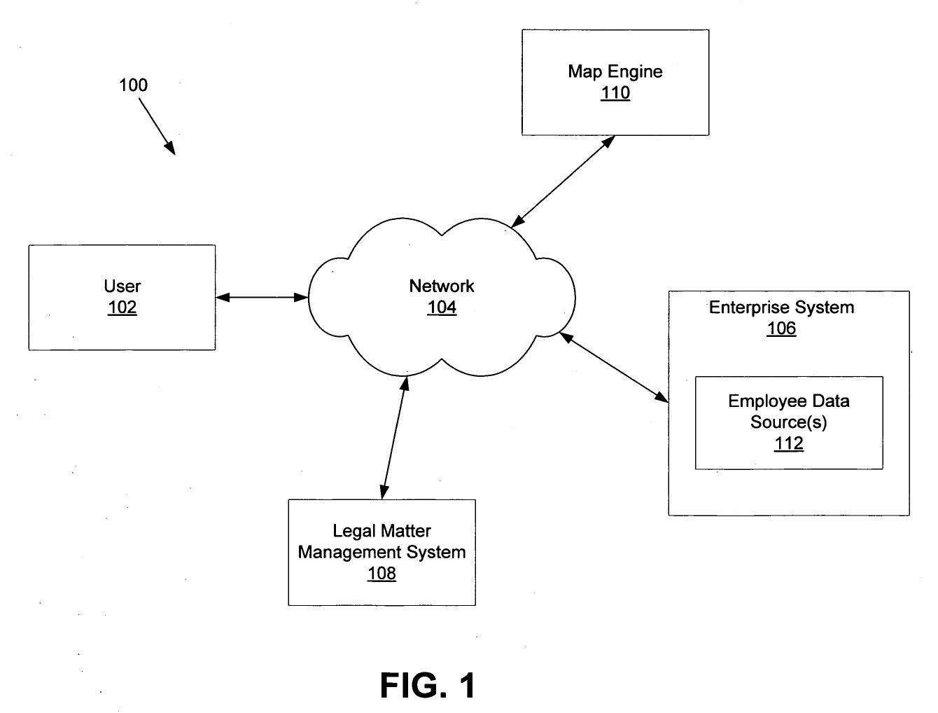

FIG. 1 shows an exemplary environment 100 in which embodiments of the present invention may be practiced. The environment 100 comprises at least one user 102 coupled via a network 104 to an enterprise system 106. In exemplary embodiments, the network 104 may be a local area network, a wide area network, peer-to-peer network, or the Internet. Alternatively, the user 102 may be coupled directly to the enterprise system 106 or access the enterprise system 106 from within the enterprise system 106. In some embodiments, more than one network 104 and/or more than one type of network 104 may be utilized to allow the components of the environment 100 to communicate with each other.

Any number of users 102 may be present in the environment 100. The user 102 may be an individual accessing the enterprise system 106 in order to cross-check employee status changes with a matter to insure evidence preservation. In exemplary embodiments, the matter is a legal matter, and may comprise, for example, a pending or potential litigation, tax inquiry, or regulatory inquiry matter. In these embodiments, the user 102 may comprise an attorney or legal staff associated with the legal matter. However, in alternative embodiments, the matter may be related to any matter of interest to the user 102 (e.g., internal investigation, policy-related examination/investigation, or audit). For simplicity of discussion, the following description will be presented with reference to a legal matter. However, it is understood that embodiments of the present invention may be applied to any type of matter.

In some embodiments, a computing device associated with the user 102 may comprise an optional business application (not shown) that performs actions related to the enterprise map. For example, the business application may interact with a legal matter management system 108 to perform the cross-checking functions described herein. In an alternative embodiment, the business application may comprise the legal matter management system 108 and/or a map engine 110 that generates the enterprise map. In other embodiments, the business application interacts with a user interface module in the map engine 110 and/or the legal management system 108, as will be discussed below.

The exemplary map engine 110 maintains a map comprising a structure that represents people, repositories, organizations, and documents via relationships. The map engine 110 utilizes information types, organizations, storage locations, people, and other objects and their relationships to provide an overall map structure that is used to derive relationships between people, repositories, and organizations. As a result, the user 102 can use the map to determine affected people and systems in the enterprise system 106. The map engine 110 and creation of the enterprise map is described in further detail in co-pending U.S. patent application Ser. No. 11/512,880, filed Aug. 29, 2006 and entitled “Systems and Methods for Providing a Map of an Enterprise System,” and U.S. patent application Ser. No. 11/505,537, filed Aug. 16, 2006 and entitled “Systems and Methods for Utilizing an Enterprise Map to Determine Affected Entities,” both of which are incorporated by reference. While the map engine 110 is shown coupled to the enterprise system 106, the map engine 110 may be comprised within the enterprise system 106, according to some embodiments of the present invention.

The exemplary enterprise system 106 may comprise any number of servers, client devices, and repositories storing data. The enterprise system 106 may further comprise a totality of IT, storage and information management systems in an enterprise, including those internally managed, outsourced, etc. The data may comprise documents, files, audio and video media, e-mail communication, and any other information which may be stored in repositories. Repositories may comprise both physical and digital storage media including warehouses, filing cabinets, hard drives, and other digital media storage devices. The repositories may be located anywhere in an enterprise (e.g., in different jurisdictions).

The enterprise system 106 also comprises one or more employee data sources 112. The employee data sources 112 provide employee status and/or employee status change information. In one embodiment, the employee data source 112 comprises a human resource (HR) management system. The HR management system comprises a master data source for employment status, such as potential, pending, or actual employee terminations, manager of the employee, and other relevant employment information. In another embodiment, the employee data source 112 comprises an employee directory. The employee directory may be accessed via a LDAP (lightweight directory adaptive protocol) directory server, for example.

In yet another embodiment, the employee data source 112 comprises an application that generates a list of pending or anticipated employee status changes, such as a reduction in force (RIF) list. The list may be generated based on employee information, status change, or expected status change information entered by one or more individuals or systems. For example, the list may be generated based on a list of employee status change “events” that are transmitted from the HR management system to the application when an employee status change is determined or anticipated. Events may comprise expected or actual employee termination or resignation, RIF lists, pending employee actions (e.g., performance review, investigations, etc.), and any other employee status change which may indicate a future (i.e., pending or potential) termination, time off, transfer, or exit of the employee. In another example, a manager may enter a list of employees that he anticipates a status change to affect.

It should be noted that employee data sources 112 are not limited to those described above. Other systems may be utilized for providing employee status change information. For example, payroll processing or other corporate information systems may be monitored for employee exits or status changes which may indicate a current or anticipated future termination or status change of an employee.

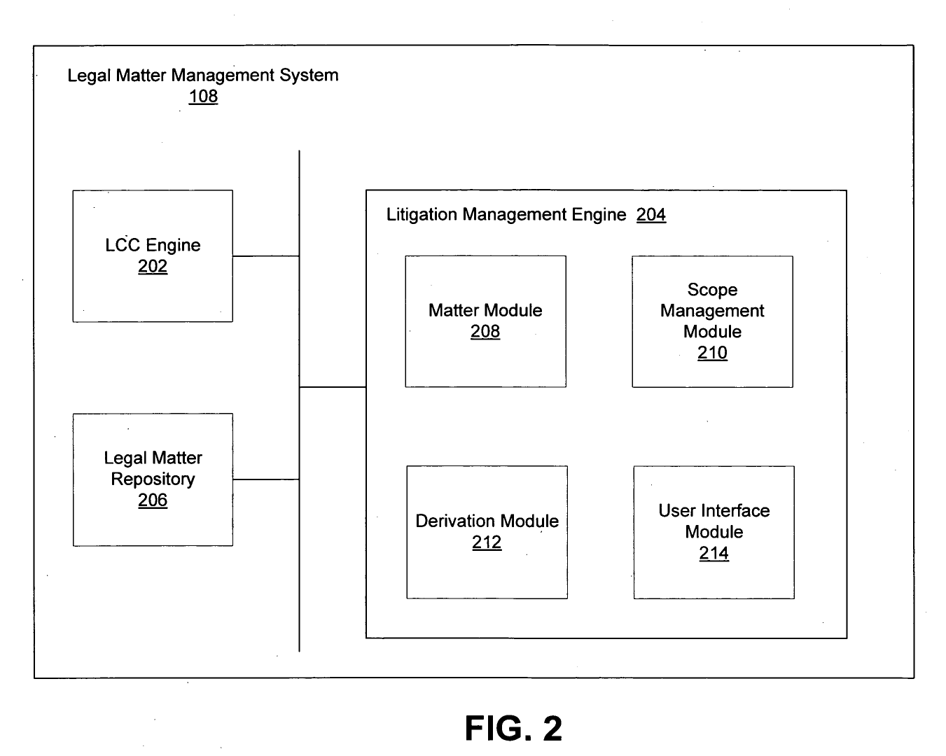

The legal matter management system 108 is configured to allow users to manage preservation and production of data associated with legal matters. The exemplary legal matter management system 108 is discussed herein as being utilized to identify people who have or will have a status change and are involved in a legal matter. In some embodiments, the legal matter may be active. However, the legal matter management system 108 may be utilized to determine affected people and systems for any reason. For example, the user 102 may use the legal management system 108 to find affected people and systems associated with a merger transaction in order to review, hold/preserve, or collect certain documents, or to interview the affected people. While the legal matter management system 108 is shown coupled to the enterprise system 106, the legal matter management system 108 may be comprised within the enterprise system 106, in various embodiments of the present invention. The legal matter management system 108 will be discussed in more detail in connection with FIG. 2.

It should be noted that the environment 100 of FIG. 1 is exemplary. Alternative embodiments may, for example, comprise the various components of the environment 100 in communication with each in a different manner. For example, a device of the user 102, the legal matter management system 108, and the map engine 110, may all, or in various combinations, be comprised within the enterprise system 106.

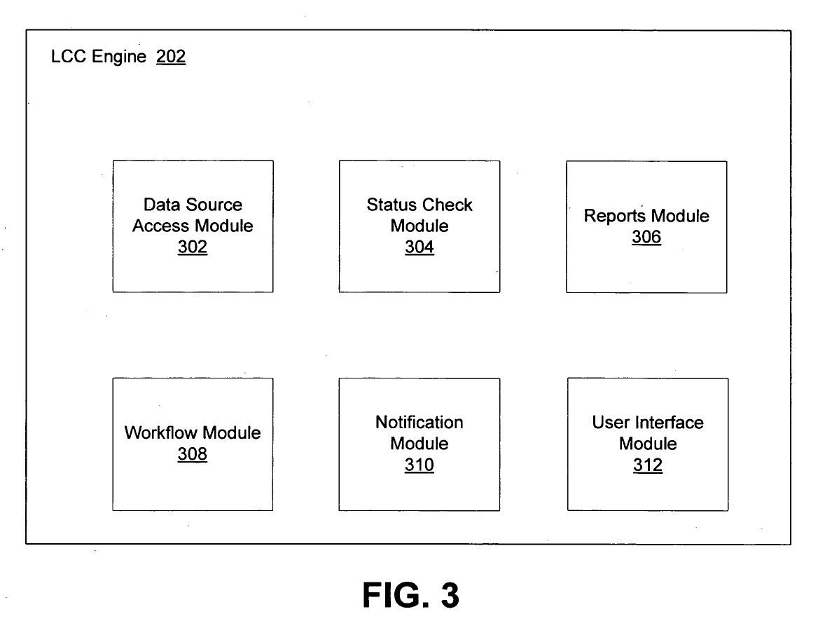

Referring now to FIG. 2, a detailed block diagram of the exemplary legal matter management system 108 is shown. In exemplary embodiments, the legal matter management system 108 comprises a legal communication and collections (LCC) engine 202, a litigation management engine 204, and a legal matter repository 206 configured for storing legal matter information. The LCC engine 202 will be discussed in more detail in connection with FIG. 3.

The litigation management engine 204 manages the legal matters within the enterprise system 106, and comprises a matter module 208, a scope management module 210, a derivation module 212, and a user interface module 214. Alternative embodiments may comprise more, less, or functionally equivalent modules. Furthermore, some of the modules of the litigation management engine 204 may be comprised in the map engine 110 or vice versa. While the litigation management engine 204 will be discussed in a context of a litigation matter, exemplary embodiments allow for the management of non-litigation matters (e.g., internal investigations, government regulatory request for information, etc.). As such, the litigation management engine 204 may comprise, and be referred to as, a legal management engine.

In some embodiments, some of the components of the litigation management engine 204 are located at a device associated with the user 102, and operate within the device of the user 102 to provide the functionalities described below. In other embodiments, the litigation management engine 204 is completely located at the device associated with the user 102. In yet other embodiments, the litigation management engine 204 is completely separate from the device of the user 102, and the user 102 accesses the litigation management engine 204 via the network 104.

The exemplary matter module 208 creates the legal matter which will be managed by the legal matter management system 108. The legal matter identifies a matter for which affected people & systems are being determined (e.g., derivation of a list of affected people and/or systems). The legal matter may also identify the attorneys and other staff that are working on the legal matter. By identifying the relevant staff, for, example, workflow may be automatically generated for the staff upon determination of the affected people and systems. Furthermore, results of the derivation may be stored based on the legal matter.

The scope management module 210 is configured to receive scope parameters from the user 102 for the derivation of key people and systems. In some embodiments, the scope management module 210 provides a graphical user interface (GUI) that allows the user 102 to provide the scope parameters. The scope parameters are one or more map objects that are known to intersect the legal matter in some manner. For example, if the legal matter involves a specific organization or information type, the user 102 can provide those objects as the scope parameters.

The derivation module 212 takes the scope parameters and traverses the map in order to determine the affected people and systems associated with the legal matter based on relationships identified within the map. In exemplary embodiments, the derivation module 212 may work with one or more components of the map engine 110 to traverse the map. Thus, knowing at least one root element (e.g., an object) associated with the legal matter, further objects and/or the affected people and systems may be derived. For example, for a given organization specific classification code (OSCC), items of data classified by the OSCC will be stored in a particular information repository (e.g., file share or document management system). Typically, there is a steward (i.e., a person responsible for the information record keeping) for each repository. These stewards are affected people which need to be notified about the legal matter.

Once the list of affected people and systems are identified by the derivation module 212, the list may be stored, for example, by legal matter. In exemplary embodiments, the list is stored in the legal matter repository 206, and comprises a list of people and systems with potential information or knowledge relevant to the legal matter. In some embodiments, the affected people and systems may also be manually identified by a user. In these embodiments, the final list of affected people and systems is a combination of the affected people and systems identified by the derivation module and by manual means. The affected people may comprise employees invoiced in the legal matter, IT staff responsible for managing data or information repositories associated with the legal matter, or records management staff responsible for the information record keeping associated with the legal matter. The list may be stored with additional information including attorney or paralegal and matter status (e.g., active, closed).

Based on the results of the derivation, various workflow and notifications may be generated. For example, requests may be sent to the affected people for evidence production or to place data in a legal hold. The workflow and notifications will be discussed in more detail in connection with the LCC engine 202 in FIG. 3.

The exemplary user interface module 214 is configured to allow the user 102 to utilize the litigation management engine 204 to derive a list of affected people and/or systems. In some embodiments, the user interface module 214 provides a graphical user interface (GUI) which allows the user 102 to provide scope parameters in order to determine the affected people and systems. In further embodiments, the user interface module 214 provides GUIs for showing results of the derivation of affected people and systems. In some embodiments, the user interface module 214 may be optional.

The legal matter repository 206 may also store collected data from affected people and systems. As will be discussed further, workflow may be generated for the collection of certain data from affected people and systems that are determined by the litigation management engine 204. According to exemplary embodiments, the collected data is stored in a central location (i.e., the legal matter repository 206). In alternative embodiments, the collected data may be stored in more than one legal matter repositories 206.

The collected data may or may not be relevant to the legal matter. The user 102, in exemplary embodiments, will review the collected data to determine the relevancy or interest level.

In exemplary embodiments, a link is made between every data file that is put into the legal matter repository 206 and the custodian (e.g., affected person) or custodial system (e.g., affected system) from which the data file is collected from. The link may be implemented in various manners. In one embodiment, the data file may be stored with a unique file name. An associated table may record, for example, the custodian name, unique file name, and collection time. In an alternative embodiment, the data file may be tagged with the custodian name, thus establishing a connection between the custodian and the data file. In exemplary embodiments, a data file may be connected to any number of custodians or custodial systems, and therefore may be connected to a plurality of legal matters. For example, a critical contract or piece of e-mail may be relevant to a plurality of legal matters. In many of these cases, there may be a custodian or custodial system that is relevant to a plurality of legal matters as well.

While FIG. 2 shows the LCC engine 202 and the litigation management engine 204 as separate engines, alternative embodiments may combine the two engines into a single engine. In further embodiments, some of the modules within the two engines 202 and 204 may be interchangeably placed in the other engine 204 and 202.

Referring now to FIG. 3, the exemplary LCC engine 202 is shown in more detail. The LCC engine 202 is configured to allow users 102 to manage communications and collections of data from affected people and systems, and in accordance with embodiments of the present invention, to determine any affected people who are subject to an employee status change. By determining affected people with pending or potential employee status changes, evidence may be collected and/or preserved prior to the employee's exit, notification of an exit (e.g., prior to a lay-off notice), or other status change. In exemplary embodiments, the LCC engine 202 comprises a data source access module 302, a status check module 304, a reports module 306, a workflow module 308, a notification module 310, and a user interface module 312.

In exemplary embodiments, the data source access module 302 is configured to access the one or more employee data sources 112 in order to obtain employee status information including employee status change information. In further embodiments, the data source access module 302 may also access legal matter information in the legal matter repository 206. In one embodiment, the data source access module 302 takes or maintains a feed with one or more of the employee data sources 112. The feed may occur at any time and interval. For example, the data source access module 302 may access a HR system nightly to take a “snapshot” of every employee in the company including their start date, term date, and/or any status changes that are pending for the employees. In one embodiment, the feed may comprise a real-time event feed such that the data source access module 302 will receive employee status information as soon as the employee status information is updated or changed.

In further embodiments, the data source access module 302 does not use a feed. In one embodiment, the data source access module 302 may query the employee data sources 112. For example, an employee directory (e.g., LDAP directory) may be queried every morning for employee status information.

There are numerous methods for obtaining employee status information, and should not be limited to those provided above. Any method may be utilized by the data source access module 302 as long as the LCC engine 202 receives information regarding personnel within the company (e.g., a unique identifier for the employees), transitions or status changes taking effect or that have taken effect, and/or dates of the transitions. Further information may be included such as reason for status changes. It should be noted that transitions or status changes may comprise migration or transfers between groups within the company, as well as transfers out of the company.

In some embodiments, the employee status information comprises employee status changes. In other embodiments, the employee status information comprises current employee status. In these embodiments, the LCC engine 202 (e.g., the data source access module 302 or the status check module 304) compares the current employee status information with previous employee status information to determine status changes.

The exemplary status check module 304 is configured to perform a cross-check of affected people or systems (i.e., the custodian or custodial system) involved with one or more legal matters with the employee status change information. In exemplary embodiments, the status check module 304 compares the employee status change information accessed by the data source access module 302 with legal matter data from the legal matter repository 206. In one embodiment, the status check module 304 reviews the legal matter repository 206 to access all legal matters having legal holds or requests. A comparison is then performed to determine if any employees are found in both data sets. In some embodiments, the status check module 304 may perform the cross-check on active legal matters, inactive legal matters, or a combination of both active and inactive legal matters. For example, if the status change information indicates that Sally Smith is leaving the company on December 31^{st}, the status check module 304 reviews every legal matter to see if Sally Smith intersects (e.g., is an affected person) with any legal matters.

Based on the cross-check, the status check module 304 determines the legal holds or requests in effect for custodians experiencing, or having an impending, employee status change (i.e., “status change custodian”). The status check module 304 may also determine a list of previously collected data from the status change custodian. The list of collected data is useful for ensuring that previously collected data is not collected a second time, thus making the collection process for the status change employee more efficient.

The reports module 306 provides a report of the results determined by the status check module 304 including a list of all matters involving the status change employee and status of information that may have been collected or need to be collected/preserved. In exemplary embodiments, the reports module 306 organizes the results and presents the results to the user 102 via the user interface module 312. The reports module 306 may also prepare reports for various audits based on the custodian, custodial systems, or legal matter. In some embodiments, the reports may be prepared based on templates.

In some embodiments, legal staff may actively monitor employee status changes by reviewing summary reports. These summary reports show, for example, status change employees with outstanding collections and workflow status. A historic record of summary reports may also be maintained as part of the record keeping for a legal matter.

In exemplary embodiments, once the litigation management engine 204 derives the list of affected people and systems for a legal matter, preservation of data or evidence comprises sending legal hold notices to the affected people, planning and executing interviews with affected people, and sending requests for actions associated with the data evidence (e.g., collection of potential evidence). The legal hold notices will instruct the affected people not to destroy data related to the legal matter. The interviews, in turn, may determine additional scope parameters to apply to the legal matter. The interviews may also identify more affected people and systems, which may or may not be within the enterprise system 106. For example, a contractor may have been involved on the legal matter.

Similarly, when the status check module 304 identifies an status change employee, the workflow module 308 may generate workflow for the preservation of data from the status change employee. For example, IT staff associated with the status change employee may be instructed not to purge the status change employee's computer until the user 102 or legal department has verified that all requests associated with legal holds involving the status change employee have been satisfied. In further examples, legal staff associate with the legal matter may schedule an exit interview with the status change (e.g., exiting) employee or expedite evidence collection from the status change employee. Additionally, an employee exit workflow process may be tagged to indicate that information preservation is required.

In exemplary embodiments, the workflow module 308 is configured to automatically generate a notification and/or collection workflow (e.g., requests). The notification workflow works in conjunction with the notification module 310 to notify the affected people and administrators of the affected systems. The collection workflow provides plans and plan executions to drive the collection of data and potential evidence associated with the legal matter. The collection plans target collection from the affected people (e.g., custodians) and systems (e.g., custodial systems and their respective stewards) for the collection of data and potential evidence prior to the status change date for the status change employee.

Additionally, the workflow module 308 may create workflow items that track status of the evidence preservation for the status change employee, and to prompt relevant employees (e.g., legal staff for the associated legal matter) to confirm and validate that actions have been taken and to handle exceptions (e.g., errors or incomplete tasks). The workflow may be driven by the status of the status change employee/custodian (e.g., when the status change employee is exiting) and status of the hold and collection process (e.g., are there legal holds, are they open collection requests, etc.). For example, if Sally Smith is scheduled for an interview on January 15^{th} (but she is leaving the company on December 31^{st}), the legal staff is notified that there is an exception that needs to be handled (e.g., Sally Smith will need to be interviewed earlier).

The notification module 310 sends the legal notices to preserve data and to collect the data or potential evidence. In some embodiments, the legal notices or alerts may be sent to the legal staff and instruct the legal staff on how and when to perform collection. The alerts may be sent to the legal staff via e-mail, pager, or any other mechanism. Additionally, escalation and wider alerting (e.g., other legal staff) may be performed when the termination date of the status change employee is within a small time frame (e.g., in the near future and requiring quick reaction by the legal staff). In other embodiments, the legal notices may be sent to one or more status change employees with instructions on how and when to perform production.

Other employees may also be notified. For example, a manager and/or records management and compliance personnel for the status change employee are notified. In another example, IT staff responsible for processing the status change employee's computer is notified of actions that should be taken. Workflow may be tracked to insure completion of IT staff processing. IT staff responsible for associated servers and applications (e.g., e-mail accounts) may also be notified. Additional legal staff may also be notified, for example, to be present at an exit interview.

A record of all notifications is maintained by the LCC engine 202. The record may comprise the legal notice, itself, along with date of transmission, and all notice recipients. This creates an audit trail which demonstrates preservation compliance.

The user interface module 312 is configured to allow the user 102 to utilize the LCC engine 202 to perform the status check. In some embodiments, the user interface module 312 provides a graphical user interface (GUI) which allows the user 102 to selected affected people/systems or a particular legal matter to perform a status check with. In further embodiments, the user interface module 312 provides GUIs for showing results of the status check. It should be noted that the functions of the user interface module 214 of the litigation management engine 204 and the user interface module 312 of the LCC engine 202 may be combined into a single user interface module located in either engine 202 or 204.

As previously discussed, some of the modules within the litigation management engine 204 and the LCC engine 202 may be interchangeably placed in the other engine 202 and 204. For example, the workflow module 306 and the notification module 308 may be comprised within the litigation management engine 204.

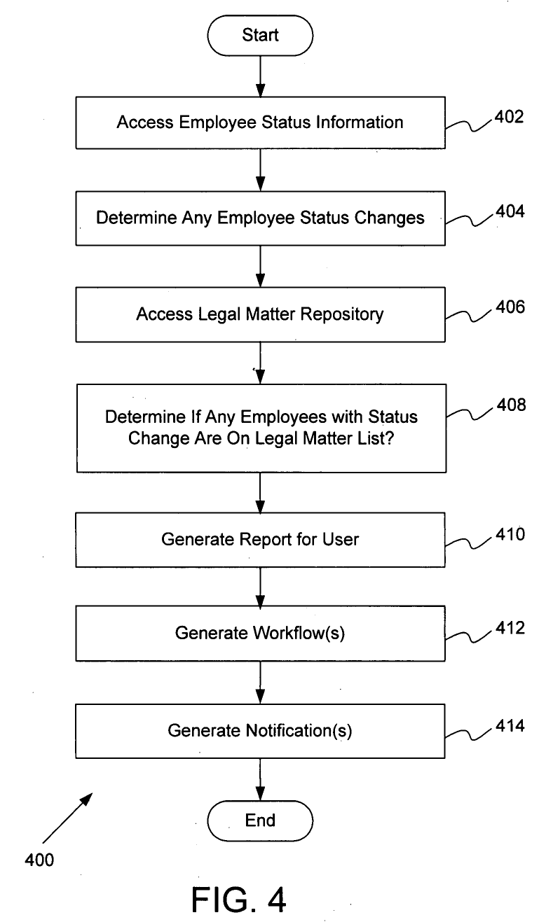

Referring now to FIG. 4, a flowchart 400 of an exemplary method for preserving evidence from an status change employee is shown. In step 402, employee status information is accessed. In exemplary embodiments, the data source access module 302 accesses one or more employee data sources 112 to obtain the employee status information. The employee data sources 112 may comprise a HR system, LDAP directory server, or any other mechanism that stores and/or provides information regarding employee status.

In some embodiments, the employee status information does not explicitly state employee status changes such as transfers between departments, resignations, and lay-offs. Instead, the employee status information may comprise current employee data. In these embodiments, employee status changes are determined in step 404. For example, the employee data source 112 may comprise a LDAP directory server which provides a current listing of employees. This current listing may be compared with a previously accessed (and stored) listing of employees to determine if any changes have occurred. The changes signify an employee status change.

In step 406, legal matter data is access from the legal matter repository 206. In various embodiments, the legal matter data is accessed by the status check module 304. In other embodiments, the data source access module 302 may access the legal matter data. The legal matter data comprises data regarding legal matters, holds, requests, and affected people and systems. It should be noted that step 406 may occur prior to, or in parallel with, steps 402 and 404.

In step 408, a determination is made as to if any employees with current or potential status changes are also involving one or more legal matters. In exemplary embodiments, the determination is performed by the status check module 304. The status check module 304 takes the list of employee status changes and cross-checks the list with affected people (i.e., custodians) and systems (i.e., custodial systems) involved in legal matters. Any employees found on both lists are identified as status change employees. In some embodiments, the status change employees are identified regardless of whether there are outstanding legal holds or requests associated with the status change employee.

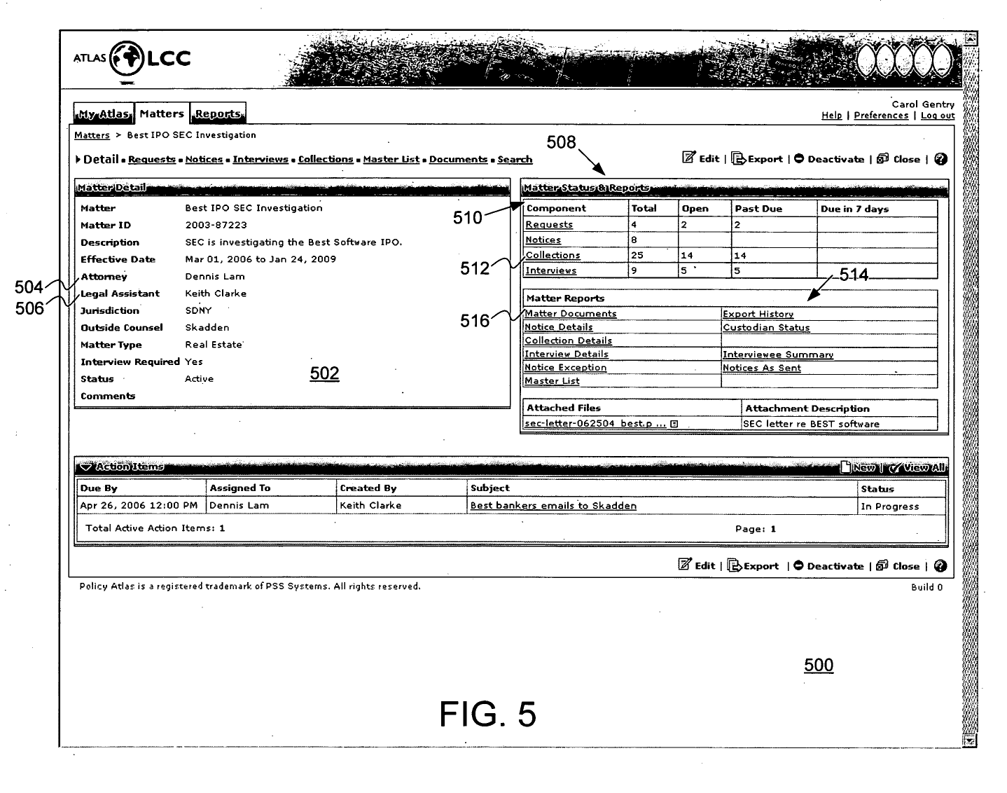

Once the status change employee(s) are identified, a report is optionally generated for the user 102 in step 410. In exemplary embodiments, the reports are generated by the reports module 306, and provided to the user 102 via the user interface module 312. Examples of reports provided to the user 102 are shown and described in connection with FIG. 5-FIG. 7.

In optional step 412, one or more workflows based on the results of the status check may be generated. Workflow may comprise any further actions that should be taken based on the results. For example, if an status check indicates that the status change custodian is scheduled to receive notice of termination in two weeks, workflow may be generated to expedite collection of evidence such that the collection is completed prior to receipt of the termination notice. Workflow may also be generated for the legal staff associated with the legal matter, IT staff associated with the status change employee, and any other employee that needs to perform some action associated with the status change employee and/or the affected legal matter.

Notifications based on the results of the status check and/or the generated workflow is generated in step 414. For example, a notice may be generated to notify legal staff associated with a legal matter that one or more status change employees have been identified for the particular legal matter. In another example, a notice may be generated and sent to the status change employee to provide certain evidence as part of a collection workflow prior to their status change. It should be noted that the method described in FIG. 4 may be performed periodically, at a user's demand, or whenever employee status change is detected.

Referring now to FIG. 5, a screenshot 500 of a user interface providing top level information for a legal matter is shown. In the present example, top level information for the “Best IPO SEC Investigation” matter is shown. In exemplary embodiments, a matter detail section 502 is provided which summarizes the top level legal matter data. The information in the matter detail section 502 may be information entered when the legal matter is first established. The matter detail section 502 may identify legal staff including an attorney 504 and legal assistant 506 associated with the legal matter. The attorney 504 and legal assistant 506 may be associated with the legal matter via the matter module 208 (e.g., when the legal matter was first established). The legal matter management system 108 further comprises contact information for the attorney 504 and legal assistant 506, so that notifications may be forwarded to the attorney 504 or legal assistant 506. It should be noted that some matters may not involve an attorney 504 or legal staff. In these embodiments, a matter manager may be associated with legal matter instead.

When the status check module 304 identifies one or more status change employees associated with the legal matter, notification and/or workflow may be sent to the attorney 504, legal assistant 506, and/or matter manager. In some embodiments, the notification is automatic. For example, if the status check module 304 detects a status change associated with the legal matter, the attorney 504, legal assistant 506, and/or matter manager are automatically notified of the change event. In further embodiments, other functions may be performed, either manually or automatically, such as recording what actions were taken by the attorney 504 or matter manager or building a workflow process.

The screenshot 500 further comprises a reports section 508. A top portion of the reports section 508 shows a matter status portion 510 having objects associated with each component. The purpose of this status portion 510 is to provide a snapshot of the status of the legal matter. For example, under collections 512, there are 35 collection workflow objects of which 14 are still open, and 14 are past due. The user 102 may select one of the components (e.g., collections) and a listing of objects (e.g., collection plans) are provided.

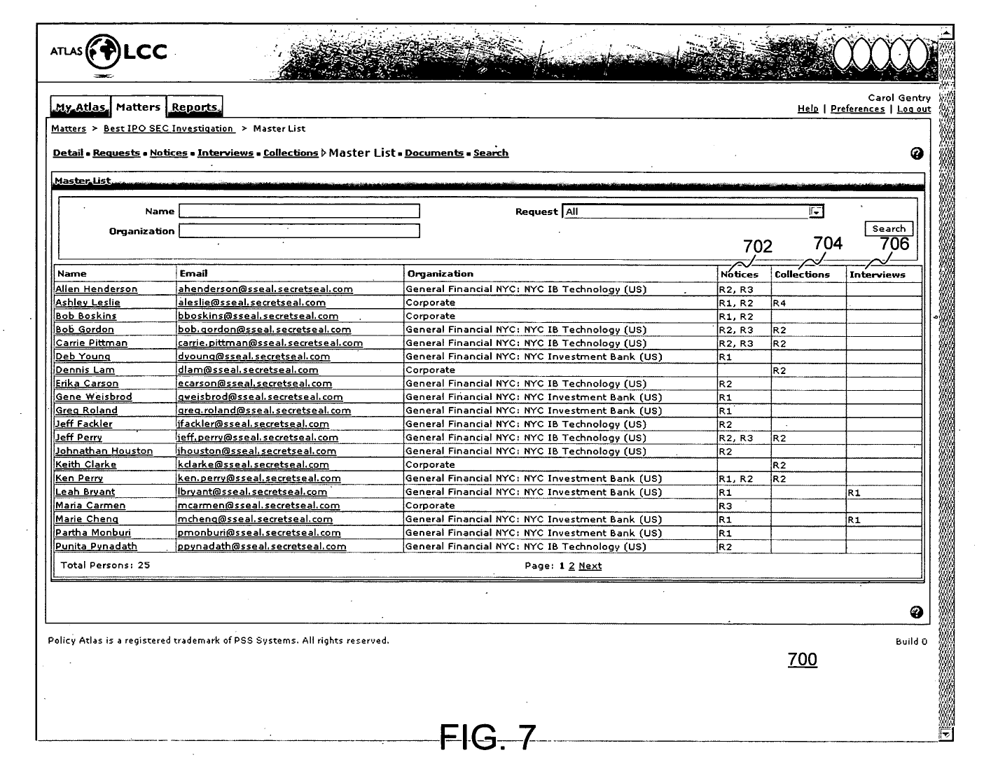

The reports section 508 further comprises a matter reports portion 514 which provides a standard set of reports. For example, a matter documents report 516 provides information about every document collected as part of this legal matter. In another example, a master list report provides a formatted version of a master list screenshot, which will be shown and described in connection with FIG. 7.

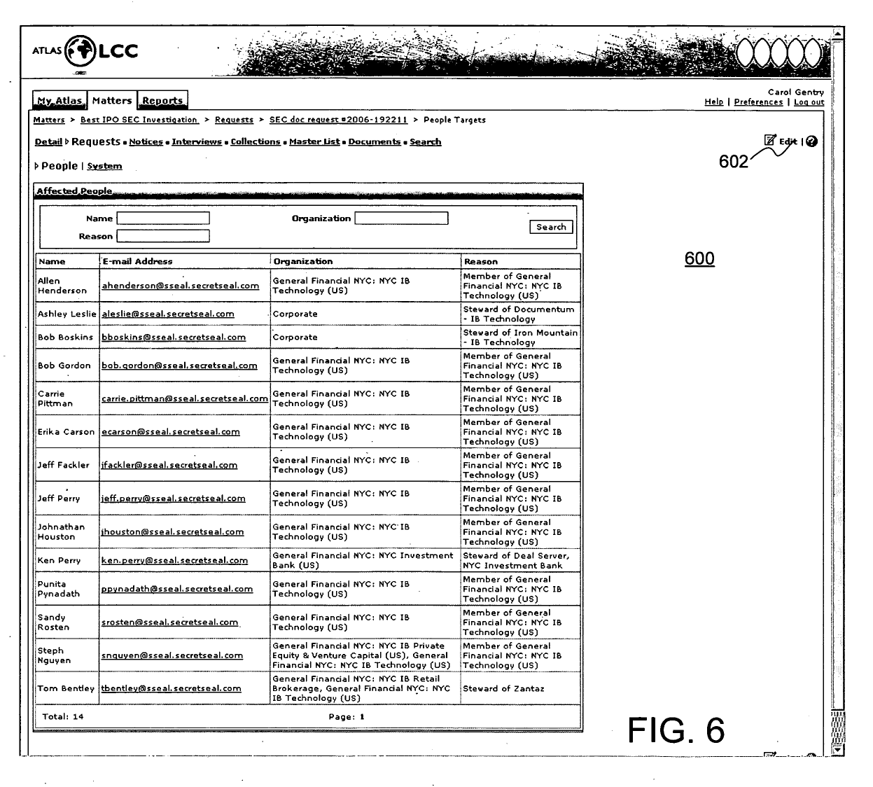

FIG. 6 is a screenshot 600 of a user interface providing a list of affected people. In exemplary embodiments, this list is generated based on some search parameter which is cross-checked against a list of all legal matters. In one embodiment, the list of FIG. 6 may comprise a listing of status change employees.

As shown, the affected people screenshot 600 provides a listing of names, e-mail addresses, organization within the company; and reason(s) why the people are associated with the legal matter. The list may be edited by selecting an edit icon 602, Thus, if the attorney 504 determines (e.g., via interviews or research) that more people should be added to the list, the attorney 504 may do so.

In exemplary embodiments, this list of affected people, along with other lists for other legal matters, are cross-checked against employee status change information by the status check module 304 to determining status change employees.

Referring now to FIG. 7, a screenshot 700 of a user interface of a master list is shown. The master list indicates all affected people that are associated with the legal matter. The master list includes previously associated people as well as currently associated people. Thus, employees who have exited the company or department are still provided on this master list.

In various embodiments, the master list provides listings of notices 702, collections 704, and interviews 706 associated with the affected employees. Thus, a record of all notices, collections, and conducted interviews is maintained for each legal matter for all affected employees associated with the legal matter. This is important in demonstrating diligence in evidence collection and preservation for the legal matter.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for determining potential evidence issues for employees having changing status, comprising:
determining employee status change;
accessing information associated with one or more legal matters; and
determining at least one status change employee, the status change employee comprising an employee having changing status or potential changing status that is associated with the one or more legal matters.

2. The method of claim 1 wherein determining employee status change comprises receiving a data feed of employee status information.

3. The method of claim 2 wherein the data feed occurs in real-time.

4. The method of claim 1 wherein determining employee status change comprise receiving current employee status, and comparing the current employee status with a previous employee status to detect any changes.

5. The method of claim 1 wherein determining employee status change comprises querying an employee data source.

6. The method of claim 1 wherein determining employee status change comprises allowing status change information to be manually entered.

7. The method of claim 1 wherein determining employee status change comprises monitoring a corporate information system for status changes.

8. The method of claim 1 further comprising generating a report comprising the at least one status change employee or matter affected by the at least one status change employee.

9. The method of claim 1 further comprising generating at least one notification associated with the status change employee or an affected matter associated with the status change employee.

10. The method of claim 1 further comprising generating at least one workflow associated with the status change employee.

11. The method of claim 10 wherein the workflow comprises scheduling an interview with the status change employee.

12. The method of claim 10 wherein the workflow comprises collecting or preserving information from the status change employee.

13. The method of claim 10 wherein the workflow comprises tagging an employee workflow process for the status change employee.

14. The method of claim 10 wherein the workflow comprises notifying others to preserve or collect data from the status change employee.

15. The method of claim 10 further comprising tracking status of the workflow.

16. The method of claim 1 further comprising providing an escalating alert as a status change date of the status change employee is nearing.

17. A system for determining potential evidence issues for employees having changing status, comprising:
at least one data access module configured to access employee status information and information associated with one or more legal matters;
a status check module configured to determine at least one status change employee, the status change employee comprising an employee having changing status or potential changing status that is associated with the one or more legal matters; and
a reports module configured to generate reports comprising the status change employee.

18. The system of claim 17 further comprising a workflow module configured to generate at least one workflow associated with the status change employee.

19. The system of claim 17 further comprising a notification module configured to generate at least one notification associated with the status change employee.

20. The system of claim 17 further comprising a litigation management engine configured to derive the information associated with the one or more legal matters.

21. A computer readable medium having a program embodied thereon, the program providing instructions for a method determining potential evidence issues for employees having changing status, comprising:
determining employee status change;
accessing information associated with one or more legal matters; and
determining at least one status change employee, the status change employee comprising an employee having changing status or potential changing status that is associated with the one or more legal matters.
